(19) United States
(12) Patent Application Publication
(10) Pub. No.: US 2002/0103706 A1
(43) Pub. Date: Aug. 1, 2002

(54) Customer information control system

(76) Inventor: Yasuhiro Toda, Tokyo (JP)

Correspondence Address: REED SMITH HAZEL & THOMAS LLP, Suite 1400, 3110 Fairview Park Drive, Falls Church, VA, 22042, US

(21) Appl. No.: 09/769,500

(22) Filed: Jan. 26, 2001

(51) Int. Cl. G06F 17/60

(52) U.S. Cl. 705/15

(57) ABSTRACT

Better service is provided to repeater (regular) customers by linking predetermined image information with the customer information to thereby control the customer information, and outputting the information on a display of a mobile image communication terminal such as high function and high performance mobile phone or/and a display or a printer of a personal computer. A customer information control system comprising: one or a plurality of cameras for taking photographs of a face or/and the whole image or/and the frame of customers, a system for encoding the image information of these cameras and transmitting the encoded information to an image server via a wired or/and wireless network line; a system for transmitting the image information of the face or the whole image of the customers to customer lists (charts) via the wired or/and wireless network line; customer information collection means for collecting customer information through questionnaires for being input or voice input; a system for encoding the customer information and transmitting the encoded information to a data server via the wired or/and wireless network line; a system for transmitting the customer information to the customer list (chart) via the wired or/and wireless network line; and a customer list (chart) in which the image information and the customer information transmitted from the data server and the image server via the wired or/and wireless network line can be related to each other and automatically listed as the identical information.

### BACKGROUND OF THE INVENTION

1. Field of the Invention

The present invention relates to a system for controlling customer information.

2. Related art

Particularly in tertiary industries such as eating and drinking business, retail stores or the like, how to take great care of customers, and in the eating and drinking business, how to make customers revisit their stores, or in retail stores, how to make customers purchase products again in their stores, that is, necessity of a so-called repeater is the most important problem.

Heretofore, in order to obtain repeaters, a customer ledger is prepared by paper cards or on a personal computer, and information on the customer ledger is read out according to need to deal with customers.

Moreover, for example, with regard to offer of delicate service to repeaters, such as invitation on the birthday of the customer, the customer becomes familiar with the owner or manager of the store by invitation, and thus service is provided depending on each customer. Therefore, if the owner or the manager of the store is retired, these services are not performed at all.

However, with high economic growth, tertiary industries such as eating and drinking business, retail stores or the like is flourishing recently. On the other hand, excessive competition becomes severe between tertiary industries, and soft reception of customers contributes to bring customers to come to the store again, though enhancement in view of taste or quality of goods is also important in order to secure a so-called repeater.

### SUMMARY OF THE INVENTION

It is, therefore, an object of the present invention to enable providing information necessary for enhancing the soft mood at the time of reception, to a shop assistant who receives a customer, even if the shop assistant has not got acquainted with the customer, such as the name and birthday of the customer, if the customer has once come to the shop.

It is another object of the present invention to enable providing information for enhancing the soft mood at the time of reception of a customer, to a waiter, for example, in a restaurant, such that though the waiter has not received the customer when the customer came to the shop before, the waiter can talk about the preference of the customer, after having got the information such as orders that the customer made at that time.

The other object of the present invention is, in officially public facilities such as police stations, hospitals, city halls, stations or schools, or in finance business such as banks, post offices, card companies or the like, or in private facilities such as convenience stores, hotels or the like, to enable providing information for enhancing the soft mood at the time of reception to the person who receives the customer.

In general, the feature of the present invention is that comfortable service can be provided to repeater customers by storing image information of a plurality of customers and identical and peculiar information of the concerned customers in respective servers, or linking these information to each other and storing these information, to thereby control the customer information, and at any time as required, outputting the image or/and peculiar customer information of a specific customer on a display of a mobile image communication terminal such as a high function and high performance mobile phone, or on a display of a fixed terminal such as a personal computer for confirmation.

As the above-described customer information, <voice> of the customer may be included, and it is one feature of the present invention to verify and recognize the customer information by means of <voice>. This includes information obtained by asking the customer about address, name, birthday or the like in a so-called questionnaire format.

The other objects, excellent features on the construction, excellent working effects of the present invention will become obvious in the description of embodiments described below.

Moreover, in the embodiments of the present invention, description will be made by means of a face, or a part of the body, or the whole image of the customer, but the present invention includes all means that can be specified by the customer, by collecting or specifying of these information, or taking photographs of the frame, shape of the ear, outline or size of the face, and positional relationship between the face, eyes and the nose, using invisible rays such as X-rays.

In general, according to the present invention, better service can be provided to repeater (regular) customers, by linking a predetermined image information with the customer information to control the customer information, and outputting the customer information on a display of a mobile image communication terminal such as a high function and high performance mobile phone, or on a display or a printer of a personal computer.

### BRIEF DESCRIPTION OF THE DRAWINGS

FIG. 1 is a block diagram of the present invention;

FIG. 2 is an illustrative explanation diagram of FIG. 1;

FIG. 3 is an overall schematic diagram for explaining the operation;

FIG. 4 is a schematic diagram showing one example of an image and character display displayed on a display such as a handy terminal;

FIG. 5 is a block diagram at the time of input, for explaining the operation in another embodiment;

FIG. 6 is a block diagram at the time of input similar to FIG. 5;

FIG. 7 is a block diagram at the time of input, for explaining the operation in another embodiment; and FIG. 8 is a block diagram at the time of output thereof.

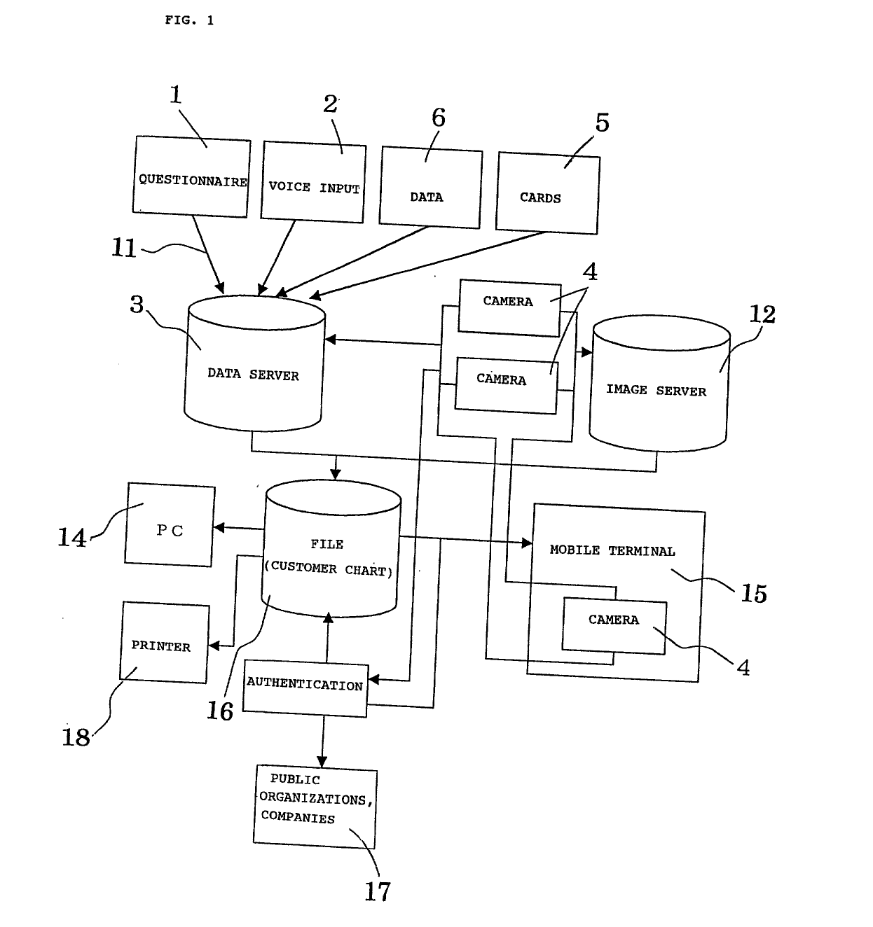

### DESCRIPTION OF THE PREFERRED EMBODIMENTS

At the time of implementing the present invention, in the drawings, reference symbol 1 denotes a questionnaire form for collecting information of a plurality of customers. This is, for example, handed over to a customer to fill in by the owner or manager of a restaurant. As the information obtained from the customer at that time, value added information is preferable, such as favorite foods, hobbies and special skills, in addition to personal information (ID) such as name, address, telephone number, domain, age, sex and family make-up. The information may be any information that can specify the customer in comparison with other customers.

This questionnaire result is input to the personal computer and turned into electronic data. Therefore, not only using such a questionnaire form, but an interview method may be used, wherein the information is verbally gathered from the customer and the customer information is collected by voice input 2.

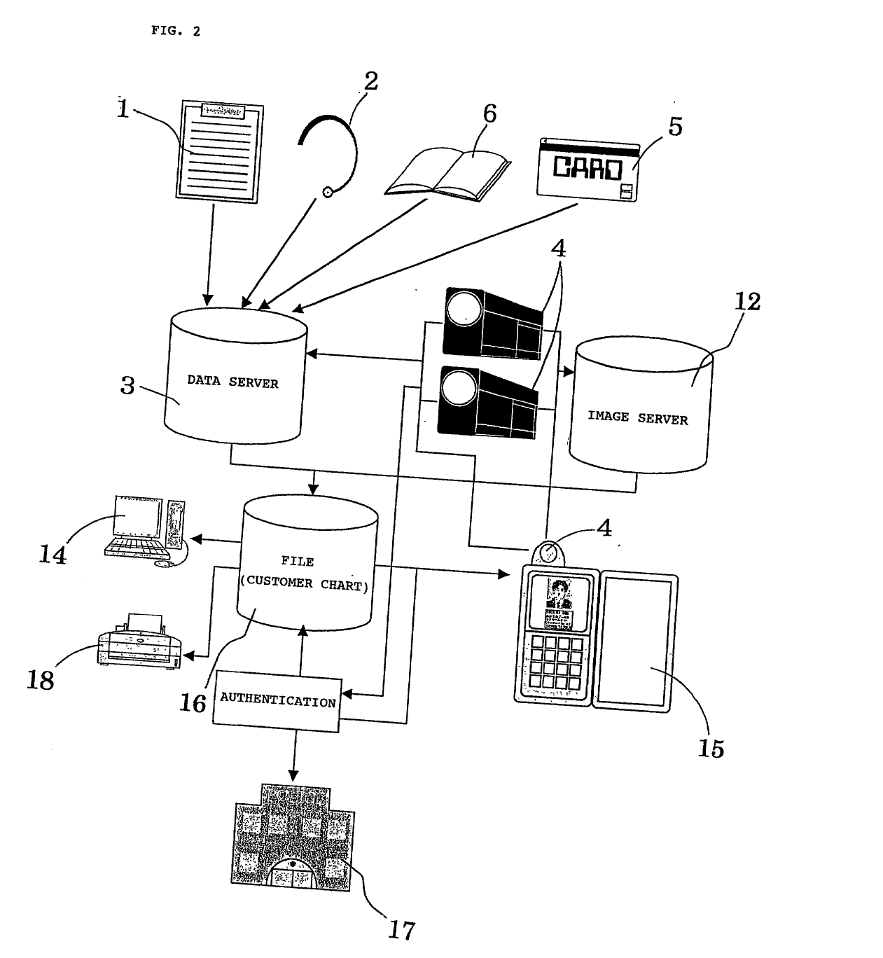

These information is turned into electronic data as described above and stored in a data server 3 via a wired or wireless network line 11, as seen in FIG. 2.

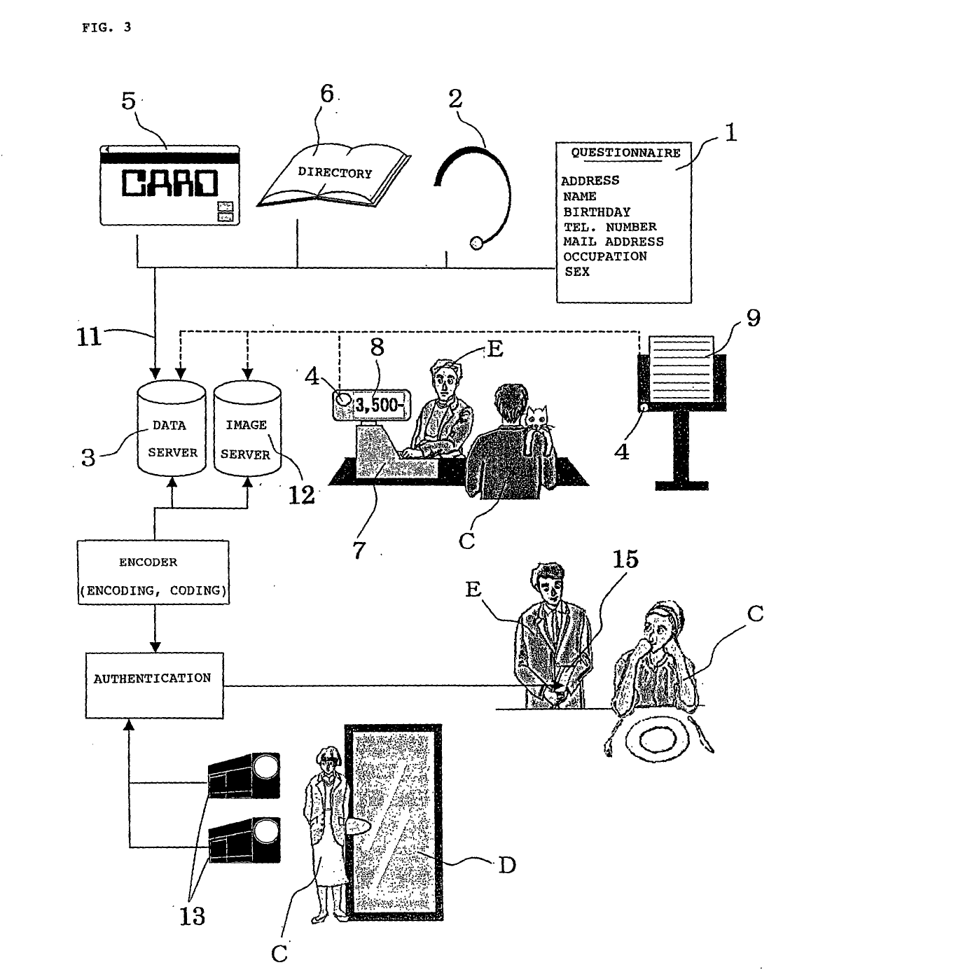

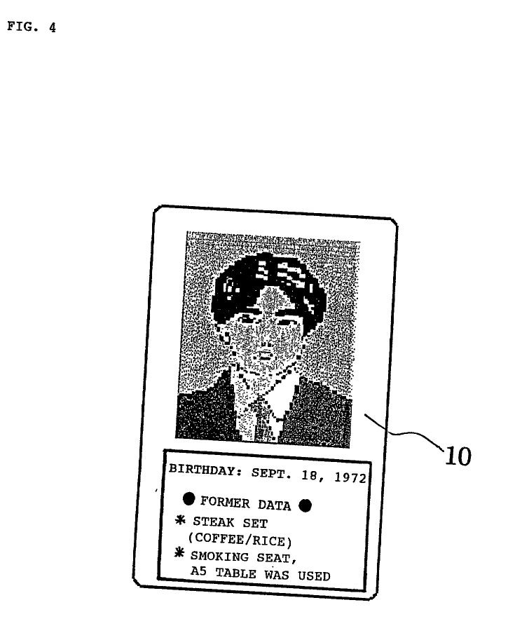

Moreover, in the figure, reference symbol 4 denotes one or a plurality of image pick-up elements such as camera, installed in a predetermined place in the store. In the case of restaurants or supermarkets, as seen in FIG. 3, this video element 4 is normally installed at the side of a display showing the total amount, such as a register 7 or the like, so as to be unnoticed.

This is because customers always turn their faces toward the display 8 showing the total amount, and hence their pictures are reliably taken, and customers do not have uncomfortable feeling because their pictures are taken.

Taking this arrangement into consideration, there is usually a nameplate stand 9 in a “store” as shown in the figure, and there is an advantage in that a video element 4 such as a camera is installed at such an unnoticed position, and if customers are asked to write their names every time they come to the store, then, information such as name can be input together with the picture of the customer without asking them.

The content of the picture to be taken is not limited to the “face” 10 of the customer, but any shooting means may be used, as long as it can specify the customer, by a part of the body or the whole body, or outline of the face, shape of the ear, or positional relationship between the face, eyes and the nose, using invisible rays.

This image data is stored in an image server 12 via a wired or wireless network line 11. In this case, it is naturally necessary to consider encoding, such as adding a file name to the data information and the image information, respectively, corresponding to each other.

The information in these both servers 3, 12 is output to a fixed terminal 14 such as a personal computer, or a mobile terminal 15 such as a mobile phone, or a printer 18, as completed necessary information, so that the information can be provided for the customer service, according to need.

Moreover, it is a matter of course that the mobile terminal 15 such as a mobile phone referred herein includes a handy terminal for a so-called order entry, used in eating houses such as restaurants.

Referring to FIG. 3, for example, in the entrance D of this store a video element 13 such as a camera which can shoot or take photograph of the face, a part of the body or the whole body, or the outline of the face or the frame of a customer C who has come to the store is installed at a predetermined position at the entrance D of this store.

Furthermore, the image information obtained by the video element 13 such as a camera is connected to the image server 12 via a wired or wireless network line 11.

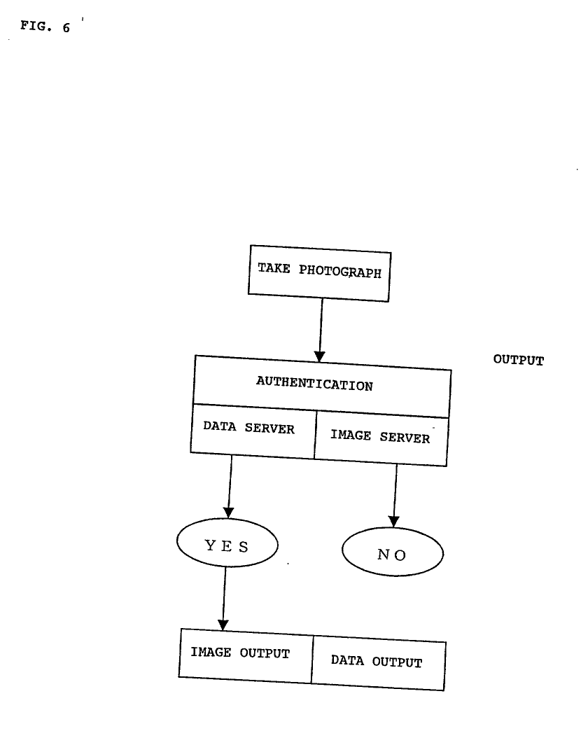

One example of the operation in the present invention will be described with reference to FIG. 5 to FIG. 8. Here, it is assumed that a visitor (customer) comes to a shop. The picture of the visitor (customer) is taken, and transmitted to the image server 12 for performing Authentication operation.

That is to say, this Authentication is for confirming whether the concerned same image has been monitored in the image server 12 or not, and as a result, if the customer has not been monitored, it means that the customer is a first time visitor. Therefore, this image data is stored in the image server 12.

As a result of this Authentication, if there is an image that agrees with the image of the customer in the image server 12, a message informing this is transmitted to a person who is receiving the customer (waiter) E.

As such means, since the reception person E is normally carries a handy terminal 15 for receiving the order of the customer, the above message is delivered to the reception person with a signal, such as lighting up the terminal 15.

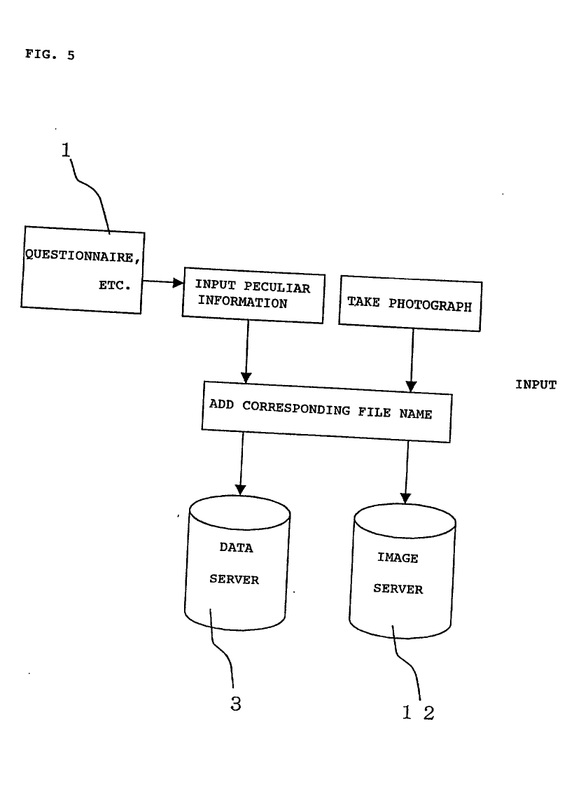

In this manner, the reception person knows that the customer he is now waiting on is a customer who has come to the shop two or several times, and hence he invokes the image of the customer that has been input last time from the image server 12, if necessary, via the wired or wireless network line 11, to be displayed on the handy terminal 15, and searches various information from the data server 3, using the file number as a key word, to display the data on the terminal 15, like a FIG. 4.

Here, the reception person confirms that the customer he is now waiting on is the same with the image displayed on the terminal 15, and at the same time, for example, seeing the menu the customer had ordered several times in the past from the data server 3, to obtain detailed customer information, such as “the preference of the customer for meat dish is sirloin”, “the preference of the customer for the cooked state of beef is medium”, “the customer orders coffee after the meal”, or “the customer likes a seat by the window”. If the waiter waits on the customer based such information, the customer is surprised at this service, and will never forget this restaurant.

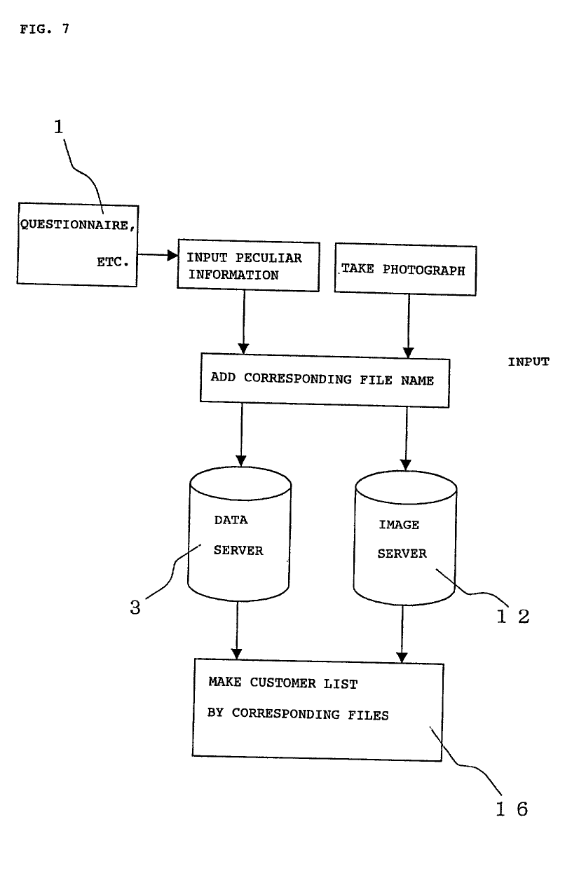

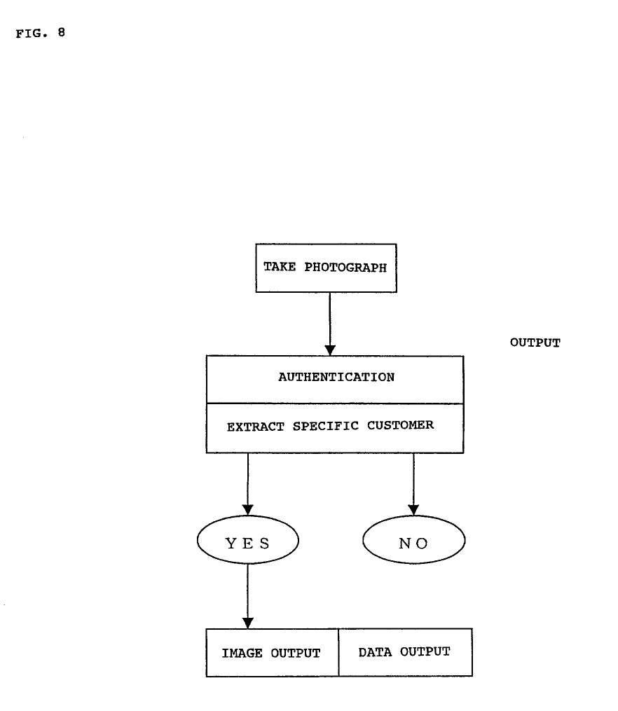

Moreover, as shown in FIG. 7, if a file 16, also referred to as “customer chart” in which the character information in the data server 3 is docked with the image information corresponding thereto is prepared in advance, when a customer who had come to this shop once comes to this restaurant again, a picture of the face or whole image or the frame of the customer D is taken by the video element 13 such as a camera installed in the shop, and the image information can be immediately verified with the file 16, also referred to as “customer chart” described above, via the wired or/and wireless network line 11, thereby identification operation of the customer information can be performed promptly.

The customer information computed in this manner is output to the fixed output terminal 14 such as a personal computer or a mobile output terminal such as the handy terminal 15, according to need, in the same manner as in the above embodiment. Then, the information can be flexibly used for the customer service, such as by providing a seat by the window to the customer who likes a seat by the window, or by asking the customer, “Last time you preferred medium, but how do you like it this time?”, at the time of confirming the cooked state of the beef, or by providing a present such as a bouquet or providing a discount service, if it is the birthday of the customer.

As another embodiment, it is assumed that the customer who has enjoyed the meal and is going to leave, wants to use a credit card for the payment. In that case, a picture of the face or the whole image, or the frame of the customer is taken by one or a plurality of image pick-up elements 4 such as cameras installed in the vicinity of the display 8 of total amount, and the image information is transmitted to the file 16, also referred to as “customer chart”, via the wired or/and wireless network line 11 for authentication.

In the file 16, also referred to as “customer chart”, which has received authentication request, the data collected in advance in the data server 3 is taken out from the customer list in the past, based on the image information, and information such as whether or not the credit card which is now being used by the customer is one in the robbery report, whether it is forged or not, or even if the credit card is of the right person, whether or not the customer is in the search for an identified criminal or search for a missing person can be obtained in a moment.

As described above, data information obtained by means of questionnaire or the like, or image information can be provided onerously or free of charge to public organizations or companies 17 that require the information. It is also possible to cooperate with various officially public facilities or private public facilities, for example, in such a manner that the police presents images of criminals beforehand to restaurants or the like for “criminal arrest”, and if the same image as those is detected, it is informed to the police.

What is claimed is:

1. A customer information control system comprising:
one or a plurality of image pick-up elements for taking photograph of the faces or/and the parts of the bodies or/and the whole image or/and the frames of a plurality of customers, and a system for encoding the image information of these image pick-up elements and transmitting the encoded information to an image server via a wired or/and wireless network line;
an input terminal for inputting peculiar information about the customers, such as birthday or the like of the customers; and
a system for encoding the input customer information and transmitting the encoded information to a data server via a wired or/and wireless network line;
wherein a photograph of a specific customer is taken again to verify the image with said image server or/and data server, to thereby output the information of said specific customer.

2. A customer information control system according to claim 1, wherein voice information of said customer is included in the peculiar information server to said customer.

3. A customer information control system comprising:
one or a plurality of image pick-up elements for taking photograph of faces or/and parts of the bodies or/and the whole image or/and the frames of a plurality of customers, and a system for encoding the image information of the image pick-up elements and transmitting the encoded information to an image server via a wired or/and wireless network line;
an input terminal for inputting peculiar information about the customers such as birthday or the like of the customers;
a system for encoding the input customer information and transmitting the encoded information to a data server via a wired or/and wireless network line; and
a customer control system body for listing the image information and customer information transmitted from said both servers via the wired or/and wireless network line automatically as the identical peculiar information;
wherein, by taking a photograph of a specific customer again, said image data and said listed identical and peculiar customer information is output on the basis of the image data.

4. A customer information search system according to claim 1, wherein said identical and peculiar customer information is a fixed terminal such as a display of a mobile image communication terminal such as a high performance mobile phone or/and a display of a personal computer.

5. A customer information search system according to claim 1, wherein in said customer control system body, the identical and peculiar information is encoded so as to be able to provide the information to users via the wired or/and wireless network line or via Internet.

6. A customer information control system according to claim 1, wherein various questionnaire information provided from said customers in questionnaires asked for the customers to fill in is also included in said customer information.

7. A customer information search system according to claim 2, wherein said identical and peculiar customer information is a fixed terminal such as a display of a mobile image communication terminal such as a high performance mobile phone or/and a display of a personal computer.

8. A customer information search system according to claim 3, wherein said identical and peculiar customer information is a fixed terminal such as a display of a mobile image communication terminal such as a high performance mobile phone or/and a display of a personal computer.

9. A customer information search system according to claim 2, wherein in said customer control system body, the identical and peculiar information is encoded so as to be able to provide the information to users via the wired or/and wireless network line or via Internet.

10. A customer information search system according to claim 3, wherein in said customer control system body, the identical and peculiar information is encoded so as to be able to provide the information to users via the wired or/and wireless network line or via Internet.

11. A customer information search system according to claim 4, wherein in said customer control system body, the identical and peculiar information is encoded so as to be able to provide the information to users via the wired or/and wireless network line or via Internet.

12. A customer information search system according to claim 7, wherein in said customer control system body, the identical and peculiar information is encoded so as to be able to provide the information to users via the wired or/and wireless network line or via Internet.

13. A customer information search system according to claim 8, wherein in said customer control system body, the identical and peculiar information is encoded so as to be able to provide the information to users via the wired or/and wireless network line or via Internet.

14. A customer information control system according to claim 2, wherein various questionnaire information provided from said customers in questionnaires asked for the customers to fill in is also included in said customer information.

15. A customer information control system according to claim 3, wherein various questionnaire information provided from said customers in questionnaires asked for the customers to fill in is also included in said customer information.

16. A customer information control system according to claim 4, wherein various questionnaire information provided from said customers in questionnaires asked for the customers to fill in is also included in said customer information.

17. A customer information control system according to claim 7, wherein various questionnaire information provided from said customers in questionnaires asked for the customers to fill in is also included in said customer information.

18. A customer information control system according to claim 8, wherein various questionnaire information provided from said customers in questionnaires asked for the customers to fill in is also included in said customer information.

19. A customer information control system according to claim 5, wherein various questionnaire information provided from said customers in questionnaires asked for the customers to fill in is also included in said customer information.

20. A customer information control system according to claim 2, wherein various questionnaire information provided from said customers in questionnaires asked for the customers to fill in is also included in said customer information.

21. A customer information control system according to claim 3, wherein various questionnaire information provided from said customers in questionnaires asked for the customers to fill in is also included in said customer information.

22. A customer information control system according to claim 4, wherein various questionnaire information provided from said customers in questionnaires asked for the customers to fill in is also included in said customer information.

23. A customer information control system according to claim 7, wherein various questionnaire information provided from said customers in questionnaires asked for the customers to fill in is also included in said customer information.

24. A customer information control system according to claim 8, wherein various questionnaire information provided from said customers in questionnaires asked for the customers to fill in is also included in said customer information.
